(19) United States
(12) Patent Application Publication
(10) Pub. No.: US 2014/0352210 A1
(43) Pub. Date: Dec. 4, 2014

(54) Ultrasonically enhanced seed germination system

(71) Applicant: Bruce K. Redding, JR., Broomall, PA (US)

(72) Inventor: Bruce K. Redding, JR., Broomall, PA (US)

(21) Appl. No.: 13/986,757

(22) Filed: Jun. 3, 2013

(51) Int. Cl. A01C 1/02; G10K 11/18

(52) U.S. Cl. CPC A01C 1/02; G10K 11/18
USPC 47/57.6; 367/137; 367/140

(57) ABSTRACT

The invention consists of a sonication and imbedding process for the uptake of water and/or other beneficial substances into a seed for the purposes of reducing the time needed for germination of a plant and the time needed for full maturity growth of the resultant plant. This invention teaches that ultrasound applied to the shell of a seed will develop micro-punctures which enable the faster absorption of water and other liquid nutrients into the seed structure. The sonic energy may be at frequencies between 15 kHz and 30 kHz for periods between about 1 and 20 minutes, and can utilize either a sinusoidal waveform or an alternating ultrasonic transmission consisting of a saw tooth wave form lasting 50 milliseconds, followed by a square wave form lasting 50 milliseconds, or such similar combination of ultrasonic transmissions. The treated seed tends to grow into a mature plant at a substantially accelerated rate.

### FIELD OF THE INVENTION

The invention relates generally to a sonication and deposition process for the uptake of water or other substances along with dissolved substances into a seed, more specifically, to a method of treating seeds with sound waves for the purpose of imparting to the seed a memory for enhanced uptake of a substance that enhances a growth characteristic of the seed or resultant plant, or otherwise adds value to the seed during commercial processing.

### BACKGROUND OF THE PRIOR ART RELATED TO GERMINATION SCIENCE

Seed dormancy is a unique form of developmental arrest utilized by most plants to temporally disperse germination and optimize progeny survival. During seed dormancy, moisture content and respiration rate are dramatically lowered. The initial step to break seed dormancy is the uptake (deposition) of water necessary for respiration and mobilization of starch reserves required for germination. Deposition is a biphasic process: I) the physical uptake of water through the seed coat and hydration of the embryo; and II) germination as determined by growth and elongation of the embryonic axis resulting in emergence of the plumule and radicle. The two phases are separated temporally, and seed that have completed phase I is said to be “primed seed,” that is, primed for phase II: germination. Phase I of deposition is also used in the commercial processing of seed, i.e. wet milling fractionation of corn and the malting process for the fermentation of distilled spirits.

Priming of seed by the enhanced imbibing of water is advantageous to plant vigor, e.g. enhanced emergence, growth and yield characteristics. Seed priming also synchronizes the germination of seed resulting in a uniform field of plants that mature simultaneously for maximal yields at harvest. In addition to water, seed priming provides access to load the seed with nutrients, microorganisms, or pest inhibitors to promote seedling establishment. By adding a molecule to the seed during deposition phase I, the molecule or organism can be stored in the primed seed and therefore, be present at planting. The “loading of macromolecules” is very efficient in the seed when compared to the addition of similar molecules to the entire field. An example is the addition of fertilizer to stimulate root growth and hasten seedling emergence. The loading of the fertilizer into the seed prior to planting is more efficacious to the seedling and cost effective to the farmer. Other beneficial molecules to be loaded into seed are hormones such as the gibberelins/gibberellic acid to promote germination, cytokinins for cell elongation and inhibitors of abscisic acid to promote release from seed dormancy. Seed cultivars could be customized to specific growing regions by the addition of triazoles (plant growth regulators which moderate the effects of drought and high temperatures) or fungicides to inhibit the growth of fungi on seed and seedlings in cool, wet soil or insecticides to combat insects that attack seedlings such as corn rootworm. In addition to macromolecules, beneficial microorganisms such as Azospirillum or Rhizobium can be loaded during seed priming as a crop inoculant.

The commercial fractionation of corn begins with wet milling. Corn is a complex mixture of starch, protein, oil, water, fiber, minerals, vitamins, and pigments. Wet milling is the process of separating the corn components into separate homogenous fractions. In Iowa, approximately 20% of the 1 billion bushels of corn harvested each year is wet milled. The wet milling industry and collateral manufacturing represent a prodigious industrial effort. As the wet milling process is constantly refined by new technologies, novel by-products can be isolated in industrial quantities, e.g. ethanol, corn sweeteners, protein peptides, and vitamins C and E. The initial step in wet-milling, steeping, has not been altered by technological innovation. Steeping involves soaking the clean and dried corn (<16% water content) in warm water until it has swollen to 45% hydration. This process takes from 30-50 hr. at temperatures of 120-130.degree. F. During the steeping process, large quantities of water are moved through massive vats of corn in a countercurrent stream. Also, during this time, beneficial microorganisms such as the lactobacteria and Pseudomonas aeruginosa growing in the steep water aid in the proteolytic cleavage of corn proteins. However, the large volumes of steep water and the time required for hydration limit the effectiveness of the bacterial digestion. The digestion by-products are purified from the steep water primarily by evaporative concentration.

The malting process is the first step in the fermentation of grain to produce alcoholic spirits. The quality of the malt (and the resulting fermentation) is dependent upon the synchronous and efficient germination of the grain. Starches stored in the seed are converted into sugars during early stages of germination. At emergence, germination is halted and converted sugars are used during fermentation for the production of ethanol. Historically, the malting process was a labor-intensive task. The grain was spread onto a “malting floor, imbibed with water from overhead sprinklers, and turned by hand daily over the course of one to two weeks to release trapped heat and gases. At plumule emergence, the starches have been converted to sugars, the germinated grain is kiln dried and ground to form malt. Microbreweries and distilleries still use variations of this old malting technique to produce high quality malt. Some distilleries induce uniform germination by the addition of gibberllic acid (GA) to produce the highest quality of malt for fermentation such as in single malt scotch distillation. GA is the plant hormone, which regulates germination. Malt production of this quality is time consuming and expensive.

Normal Plant Germination

Water is the key factor that aids the germination of a seed. A seed can be prepared for germination by moistening. Care to be taken not to over soak the seed fully in water. When water penetrates the seed, the seed bulges as shown in FIG. 1. When the seed coat softens, the seed breaks and the seedling emerge out. Seed usually have some amount of stored food inside. When treated with water, this food is supplied to the seedling, aiding germination. FIG. 2 illustrates the growth of a plant from germination to full development.

You will see a wide variety of trees in your surroundings. Trees play important role in maintaining ecosystem and keeping the environment refreshing and pollution-free. Whenever you watch small or big trees, plants or shrubs, you must be curious about their growth and life cycle. Life cycle of any plant is divided in different phases and seed germination is basic stage to start the growth of plant. You may think that seed is lifeless, but it is not true. It consists of plant in a resting, embryonic condition. Whenever it gets favorable environmental conditions, it starts to germinate. This process occurs through different steps in seed germination. Inactive seed lying in the ground needs warmth, oxygen, and water to get developed into plant.

Seed Structure

Seed coat is outer covering of seed, which protects embryo from any kind of injury, entry of parasites and prevents it from drying. Seed coat may be thick and hard, or thin and soft. Endosperm is a temporary food supply, which is packed around embryo in the form of cotyledons or seed leaves. Plants are classified as monocots and dicots depending upon number of cotyledons.

Requirements for Seed Germination

All seeds need adequate quantity of oxygen, water and temperature for germination. Some seeds also need proper light. Some can germinate well in presence of full light, while others may require darkness to start germination. Water is required for vigorous metabolism. Soil temperature is equally important for appropriate germination. Optimum soil temperature for each seed varies species to species.

Factors

There are several factors that can affect germination process. Over watering can prevent the plant to get enough amount of oxygen. If seed is deeply planted in soil, then it can make to use all the stored energy before reaching soil surface. Dry conditions can prevent germination, as seed doesn't get enough moisture. Some seeds have so hard seed coats that oxygen and water get through it. If soil temperature is extremely low or high, then it can affect or prevent germination process.

Steps Involved in Germination:
1. Seed absorbs water and seed coat gets burst. It is the first sign of germination. There is an activation of enzymes, increase in respiration and plant cells get duplicated. A chain of chemical changes starts which leads to development of plant embryo.
2. Chemical energy stored in the form of starch is converted to sugar, which is used during germination process. Soon, embryo gets enlarged and seed coat burst opens.
3. Growing plant emerges out. Tip of root first emerges and helps to anchor the seed in place. It also allows embryo to absorb minerals and water from soil.
4. Some seeds require special treatment of temperature, light or moisture to start germination.
5. Steps in seed germination can be different in dicots and monocots.

Germination in Dicots

During germination process of dicots, primary root emerges through seed coat when seed is buried in soil. Hypocotyl emerges from seed coat through soil. As it grows up, it takes the shape of hairpin, known as hypocotyl arch. Epicotyl structures, pluinule, are protected by two cotyledons from any kind of mechanical damage. When hypocotyl arch emerges out from soil, it becomes straight, which is triggered by light. Cotyledons spread apart exposing epicotyl, which contains two primary leaves and apical meristem. In many dicots, cotyledons supplies food stores to developing plant and also turns green to produce more food by the process of photosynthesis.

Germination in Monocots

During germination of grass seeds such as oats or corn, primary root emerges from the seed and fruit and grows down. Then, primary plant's primary leaf grows up. It is protected by a cylindrical, hollow structure known as coleoptile. Once the seedling grows above soil surface, growth of coleoptile is stopped and it is pierced by primary leaf.

Of course, all the seeds lying in ground are not lucky enough to get proper environment to germinate. Many seeds tend to get dried and cannot develop into a plant. Some seeds get sufficient amount of water, oxygen, and warmth, and seed germination starts.

Climate Change and Reduction of Plant Growth Times

As climate change globally can affect the time available for crop growth, generally making conditions for growth more severe and the growing periods shorter, the need to reduce and enhance seed growth and eventual plant production and harvesting within a shorter time period become apparent.

Thus, a need exists for (1) a method to enhance the ability of seeds to imbibe water and other substances and to (2) reduce the time needed for plant growth.

Sonification of Seeds

The invention describes a novel sonication and deposition process aimed at the treatment of seeds for the purpose of enhancing the speed of both germination of the seed and the resultant growth of the plant that emerges form the sonication treatment. Further the inventions uses a unique for of ultrasound to impart micro holes in the outer shell of the seed, thereby enabling the seed to increase it absorption rate of moisture and nutrients. The creation of the micro-holes in the seed shell structure enables the treated seed to germinate at a faster rate. In tests the savings in germination time is as much as 55% over conventionally grown seeds.

The invention also imparts an enhanced stable memory for subsequent uptake of a substance into a seed, particularly a substance useful for enhancing a growth characteristic of the seed with that characteristic transferring to an advantage for the resultant plant, and for the uptake of water into seeds for processing purposes. The growth characteristic is enhanced through the use of ultrasound, transmitted either using a sinusoidal ultrasonic transmission or one which employs alternating ultrasonic transmissions which rotate from one ultrasonic waveform to another, the ideal embodiment being saw tooth to square waveform.

In the way of further illustrative examples of applications of the present invention, it is anticipated that the present method is applicable to soften the outer shell layer of a seed's shell as seen in FIG. 1 using an ultrasound based treatment system, to better allow the cracking of the seed shell itself, and removing or penetrating the outer shell layer of the seed. This has the effect of speeding the germination of the seed, i.e. the ability of the seed to germ. As demonstrated herein, the sonication and deposition process of the present invention would dramatically reduce the time required for germinating by accelerating the uptake of the water solution into the seed itself.

The biochemistry of this process begins with the deposition of water through the seed coat and into the interior of the seed. Using corn seeds as an example: The water reacts with the cell embryo in a manner that releases a chemical known as gibberellic acid (GA), a plant hormone. The GA is transported throughout the seed until it arrives at the aleurone layer that surrounds the endosperm. In the aleurone layer 1, the GA acts to turn on certain genes in the nuclear DNA. The genes are transcribed resulting in the creation of messenger RNA, which interacts with a ribosome to begin the process of protein synthesis, or translation. The result is the creation of a protein called amylase. The amylase is transported out from the aleurone cells and into the endosperm. The amylase is an enzyme that acts as a catalyst for the hydrolysis of starch into sugar.

FIG. 2 illustrates the normal growth range from a germinated seed to a mature plant. The goal of this invention is to reduce the time need to mature a plant, and thusly reduce the time needed to harvest a particular crop, through the use of ultrasonic transmissions applied to the seeds.

The sonication and deposition process of the present invention is directed in particular to such important agricultural seeds as corn, barley, and soybeans, wheat, tomatoes and other crops by the sonication of such seeds in a liquid medium, preferably water. Again, those of ordinary skill in the art will appreciate the applicability of the present invention to other seed types, without departing from the intended scope. The sonication is by the application of sound waves at ultrasonic frequencies from between about 15 kHz and 1750 kHz and preferably between about 20 kHz and 175 kHz, with an optimum near 23 kHz. Higher ultrasonic frequencies in the megahertz range are possible but there is a chance of seed damage. Intensity or power output can be varied in different seeds for increased speed of germination. In the following experiments just 0.5 watts of energy were employed but ranges could be from 0.125 mW/sq·cm to as high as 10 watts/sq·cm.

Ultrasonic energy is applied to the liquid and seed mixture by a sound transducer immersed in the liquid medium. While not wishing to be bound by any particular theory as to the mechanism of the subject of the invention, it is currently believed that the acoustic energy is carried through the liquid by oscillations of the liquid molecules in the direction of propagation. This produces alternating adiabatic compressions and decompressions together with corresponding increases and decreases in density and temperature. If the periodic decreases of pressure in the liquid are sufficiently high during the negative pressure phase, the cohesive forces of the liquid may be exceeded, at which point small cavities are formed by the process of cavitation. These small cavities then rapidly collapse, producing a very large amplitude shock wave with local temperatures up to a few hundred degrees centigrade or more. The collapse of the cavities is also known to create electrical discharges upon their collapse, giving rise to the effect known as sonoluminescence.

Critical to the process is the revolution of the seed within the liquid carrier or slurry, so that the ultrasound can reach all the surface of the seed during sonification.

FIG. 3 and FIG. 4 describe the process of cavitation. The effects of cavitation are greatly enhanced through the introduction of a variety of gases into the liquid. In the early 1930s, Frenzel and Schultes observed that photographic plates become exposed or fogged when submerged in water exposed to high frequency sound. This observation was the first recorded for the emission of light by acoustic waves or sonoluminescence. The physics of the phenomenon are not well understood.

With regard to the present invention, degassed distilled water requires an energy density level of approximately 1 to 10 watts/cm.sup.2 before cavitation occurs. By saturating the water with a noble gas, such as one or more of the inert gases helium, neon, argon, krypton, xenon, or radon, cavitation effects are seen at much lower energy density levels and the effects at energy density levels on the order of 1 to 10 watts/cm.sup.2 are greatly enhanced. This effect is believed to be due to the creation of microbubbles, which more easily form the small cavities upon the application of sonic energy. Additionally, the cavities in the presence of the saturated gas are believed to generate shock waves of larger amplitude upon collapse of the cavities than are achieved with degassed water. In particular, it is believed that when tap water was saturated with argon gas, helium gas, or argon and helium gasses, generally more dramatic uptake will be observed and such effects were reproducible from experiment to experiment. Other experiments in which the saturating gas was nitrogen also exhibited enhanced effects, but not nearly as pronounced as with argon. However, some experiments conducted with tap water and with boiled double distilled water also produced satisfactory results.

Since cavitation results in mechanical stress, sonication may create or enlarge fissures in the seed coat pericarp similar to scarification, a well-known process by which certain seeds, especially seeds with thick seed coats, are able to germinate. Scarification is believed to accelerate the deposition of water through the pericarp. Simple scarification is unlikely to explain the novel effect disclosed herein, since scanning electron micrographs suggest no increase in the number of fissures in treated seed, but do indicate a change in pericarp texture. It has been found that the sonication process accelerates the deposition of water. Cavitation may also result in physiological or biochemical changes in the seed that prime the germination process so that upon exposure of the seed to planting conditions, less time is needed for the seed to initiate germination, measured by the time when the radicle pushes through the pericarp. One mechanism proposed for causing physiological or biochemical changes is the production of free radicals by cavitation.

Reference is made to U.S. Pat. Nos. 5,950,362, 6,195,936, 6,250,011 and 6,452,609 which discuss the use of gases combined with cavitation forces to effect increased germination in certain seed stocks. These references rely upon cavitation forces to effect Scarification to the seed shells. However none of these works take note of the fact that convention ultrasound, developed by sinusoidal sonification, can impart extreme heat to a surface and thereby cause a melting of the seed shell as seen in FIG. 14, wherein a wheat seed has been subjected to sinusoidal ultrasound for 5 minutes. Such treatment can impart cavitation forces as described in FIGS. 3 and 4, which create an implosive and very hot cavitation force upon the seeds surface, leading to a melting of the seed shell, and thereby rendering increased or speedier germination non-existent or spotty at best. Neither do the above reference works relate that the seed needs to be rotated within the ultrasonic transmission field so that all of the shell is exposed to sonification. Without such complete sonification the seed has been found to be poorly sonicated and therefore does not germinate properly. Additionally the invention discloses the use of either sinusoidal or alternating ultrasonic waveforms for the treatment of seeds for the purpose of speeding the germination period. The prior art does not take into account the use of alternating ultrasonic waveforms for the treatment of seeds, where in cavitation can be minimized but the physical force of the sonification does in fact lead to faster germination of the treated seeds. Likewise the prior art does not disclose that sinusoidal ultrasound applied to a rotating targeted seed, can be still utilized in a manner to minimize cavitation or seed—shell burning, and still lead to faster germination of the treated seeds.

### SUMMARY OF THE INVENTION

The invention consists of a sonication and deposition process for the uptake of water and/or other beneficial substances into a seed. The seed to be treated is immersed in water or other liquids. The seed is exposed to sound energy at frequencies between 15 kHz and 30 kHz for periods between about 1 and 15 minutes. The invention is the discovery that both cavitation ultrasound and the use of alternating wave form ultrasound can be employed to treat various seeds to increase the speed of germination of the seed, and therefore reduce the time for plant growth maturity.

Cavitational Ultrasound

Sinusoidal ultrasonic energy generates cavitational forces by the adiabatic collapse of micro bubbles in the liquid medium, particularly those bubbles that collapse at the surface of the seed. The ultrasonic cavitational forces impart an enhanced stable memory for the seeds to imbibe water and/or other substances beneficial to the seed and/or plant. The ultrasonically treated seed can be dried, stored, and later imbibed with a substance that enhances a growth characteristic of the seed or resultant plant. Upon germination, the plant maintains the enhanced growth characteristics.

Alternating Ultrasonic Transmission

Alternating the ultrasonic transmission where the first part of the transmission is a saw tooth wave form lasting 50 milliseconds, followed by a square wave form lasting 50 milliseconds, in the preferred embodiment but other variations of the alternating sonic wave form can be employed. The alternating ultrasonic transmission applies the ultrasonic energy and the effect of faster seed germination more effectively than the use of Sinusoidal cavitational ultrasonic energy generates seed germination. FIG. 5 is an illustration of the alternating ultrasonic waveform method wherein the starting waveform is exited after so many milliseconds and converts to an entirely new waveform, thus avoiding cavitation.

### OBJECTS OF THE INVENTION

A purpose of the invention is to impart upon seeds through a sonication and deposition process a memory for the enhanced uptake of a substance with a beneficial growth characteristic.

A purpose of the invention is to impart upon seeds through a sonication and deposition process a further means of reducing the time needed for germination of the seed, and therefore to speeding the maturing of the resultant plant.

These and other objects of the invention will be made clear to a person of ordinary skill in the art upon a reading and understanding of this specification, the associated drawings, and appending claims.

### DETAILED DESCRIPTION OF THE INVENTION

### Brief Description of the Drawings

FIG. 1 is a photograph of a germinated seed.

FIG. 2 is a depiction of the process of seed germination to a developed plant

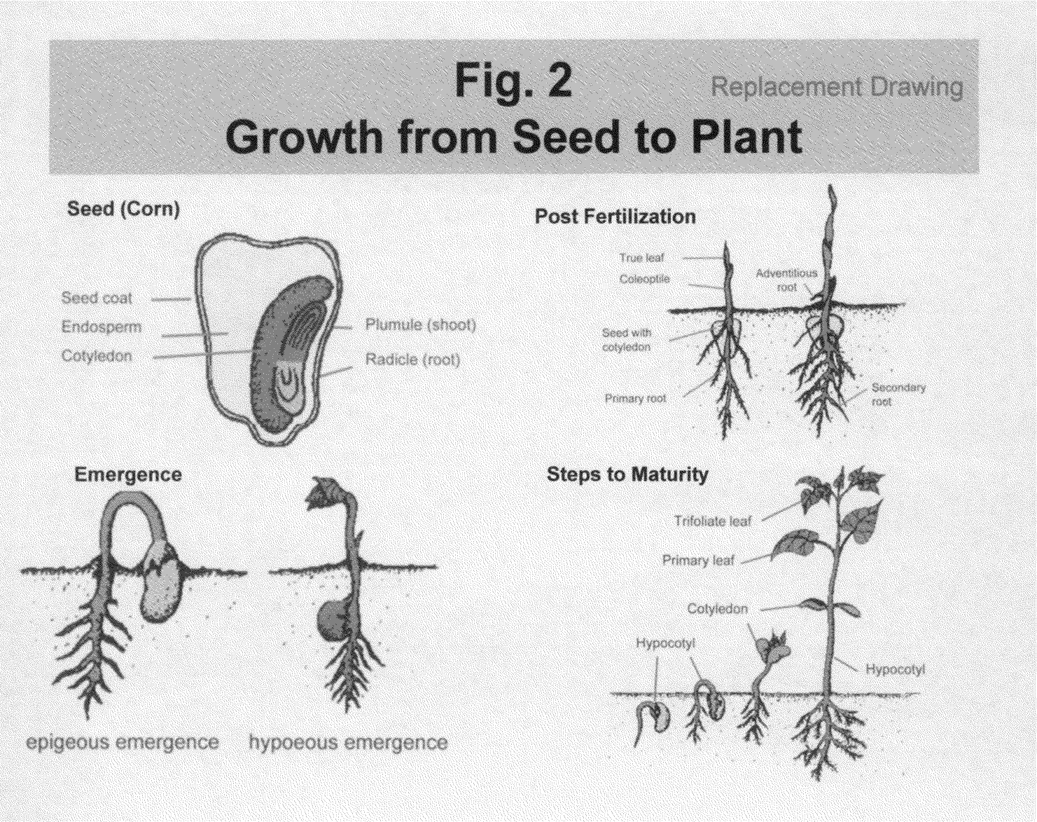

FIG. 3 Shows the process created by sinusoidal ultrasound leading to cavitation.

FIG. 4 is a further illustration of the process created by sinusoidal ultrasound leading to cavitation.

FIG. 5. is the preferred embodiment of this invention wherein an alternating wave form of ultrasound is employed to reduce the time needed for the germination of a seed and the speedier development of resultant plants or crops.

FIG. 6 is a batch process schematic of this invention where ultrasound is used to speed the germination of seeds, employing a laboratory system for the application of ultrasound to seeds.

FIG. 7 is a continuous process schematic of this invention, employing an ultrasound flow cell, where ultrasound is used to speed the germination of seeds, employing a method by which seeds in a slurry are carried directly within the patch of an ultrasonic horn within an enclosure.

FIG. 8 is a continuous process schematic of this invention, employing a ultrasound flow pipe, where ultrasound is used to speed the germination of seeds, employing an array of ultrasonic transducers within a flow pipe for the application of ultrasound to seeds.

FIG. 9 is a continuous process schematic of this invention, employing an ultrasound flow pipe, where ultrasound is used to treat seeds, which transverse the pipe, employing a filtration system for filtering the seeds form the water or solution and then delivering the wet seeds to a conveyor heater which drives the remaining moisture form the seeds, just prior to packaging the treated seeds.

FIG. 10 is a design for an ultrasonic transducer system capable of generating an alternating ultrasonic waveform transmission.

FIG. 11 is a transducer array consisting of multiple transducer elements.

FIG. 12 is a Scanning electron microphotograph of a collection of untreated, or raw, Wheat seeds.

FIG. 13 is a Scanning electron microphotograph of a collection of ultrasonically treated, Wheat seeds, processed according to Experiment 1.

FIG. 14 is a Scanning electron microphotograph of a collection of ultrasonically treated, Wheat seeds, wherein the seeds have been exposed to traditional sinusoidal ultrasound, showing the melting of the outer layer of the seed shell.

FIG. 15 is a photograph of regularly grown tomato (Grown to maturity in 80 days) Vs. Ultrasonically treated Tomato seeds grown to maturity in 35 days.

FIG. 16 is a photograph of regularly grown tomato (Grown to maturity in 80 days) Vs. Ultrasonically treated Tomato seeds (grown to maturity in 35 days), both top and side views.

FIG. 17 is a photograph of regularly grown tomato (Grown to maturity in 80 days) Vs. Ultrasonically treated Tomato seeds (grown to maturity in 35 days), both cut open views to show the meat of the fruit.

FIG. 18 is a close up photograph of regularly grown tomato (Grown to maturity in 80 days) Vs. Ultrasonically treated Tomato seeds (grown to maturity in 35 days), both cut open views to show the meat of the fruit.

FIG. 19 is a summary of the germination advances and the advances discovered in the full planting of the test crops using this invention to speed harvest times for the select crops.

### DESCRIPTION OF THE INVENTION

Mechanics of the Invention

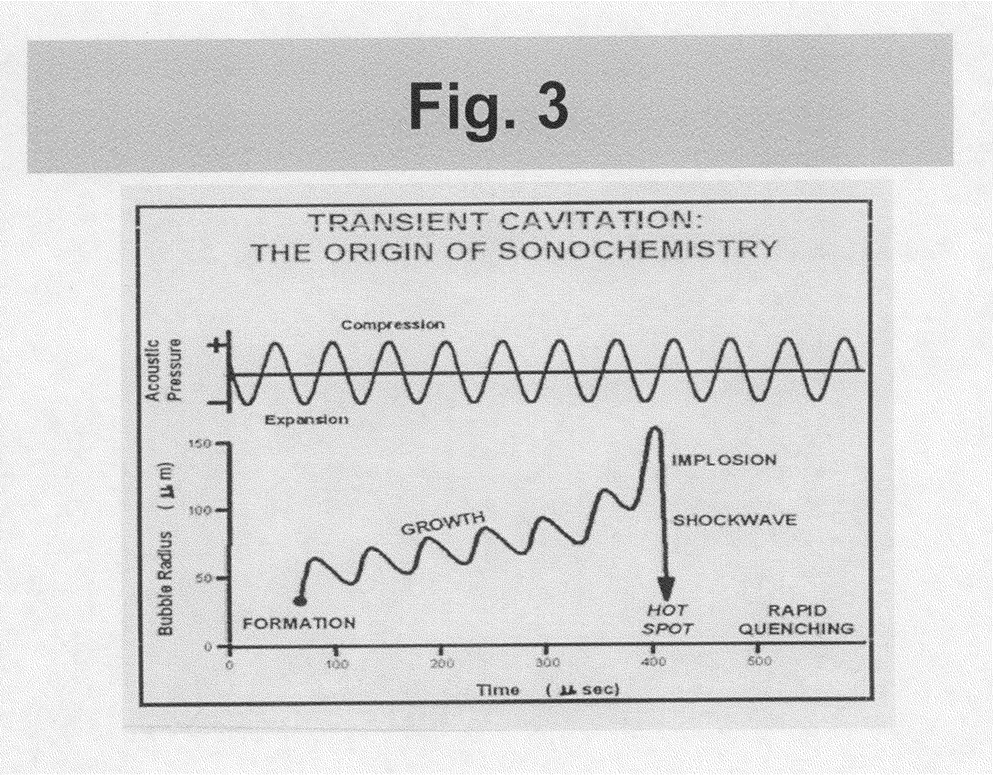

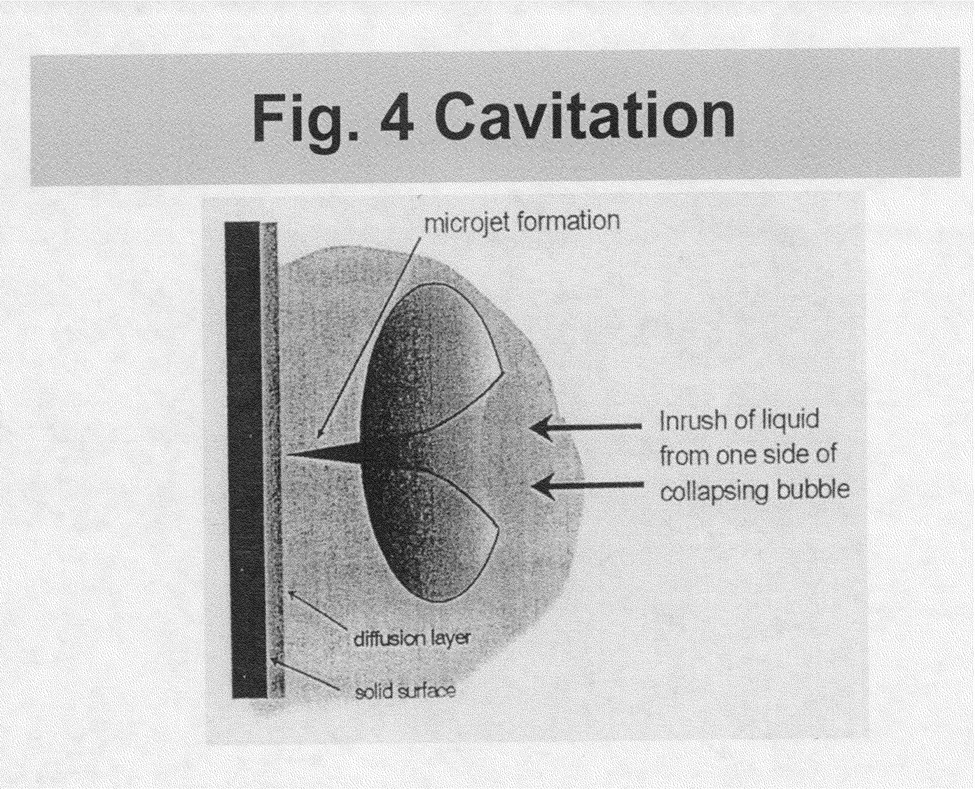

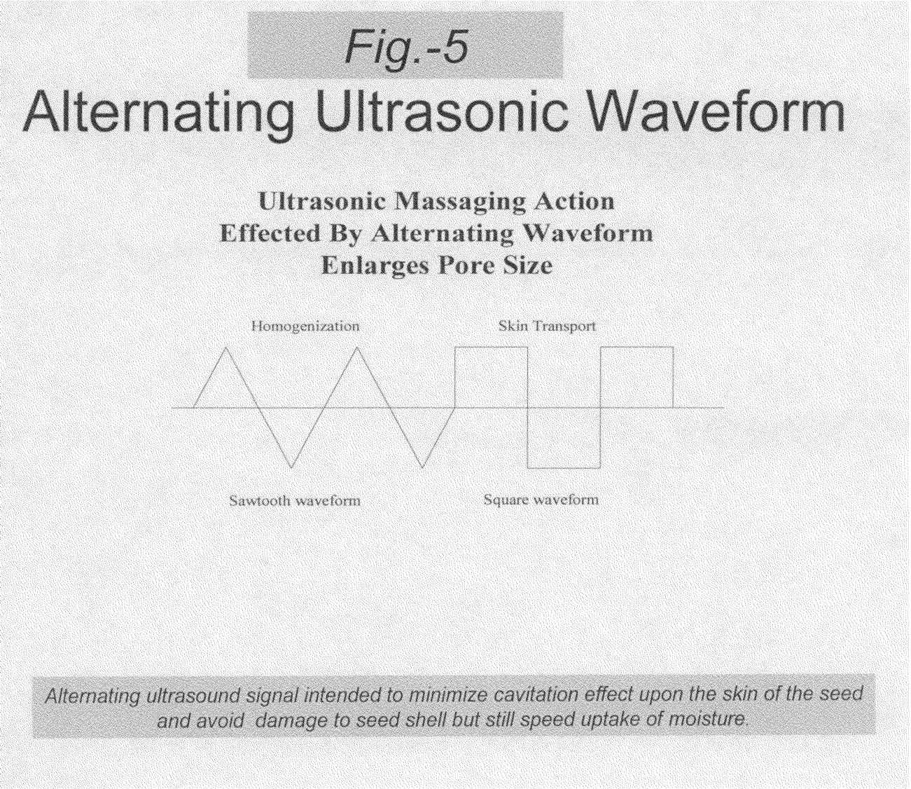

There are two differ′ent methodologies for generating an ultrasonic transmission; (1) convention sinusoidal ultrasound which imparts heat to a subject through the process of cavitation as seen in FIG. 3 and FIG. 4., and (2) an alternating ultrasonic waveform system which carries little of no cavitation heat energies as seen in FIG. 5.

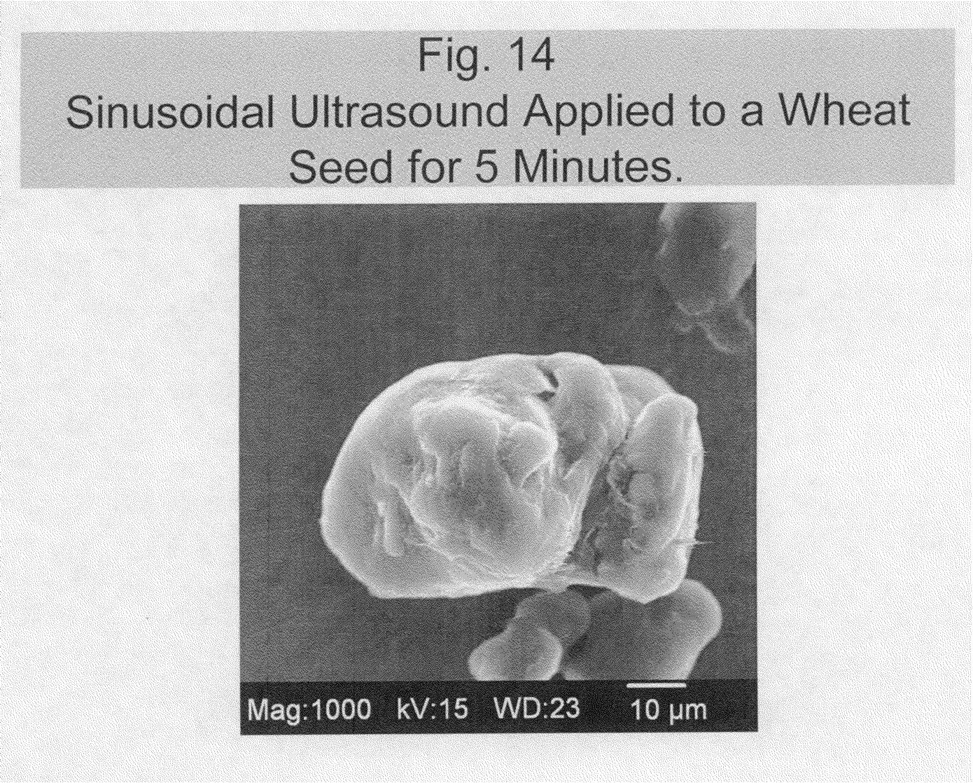

In FIG. 3 a typical sinusoidal ultrasound transmission is illustrated which imparts an implosion shockwave to a subject producing intense momentary hot spots upon the surface of the subject. FIG. 4 shows that a typical sinusoidal ultrasound transmission often forms a bubble within a liquid which implodes and again generates intense heat upon cavitation. In the treatment of seeds the use of a typical sinusoidal ultrasound transmission can lead to seed-shell damage as depicted in FIG. 14 which demonstrates the damage done to a wheat seed after 5 minutes of exposure. FIG. 14 shows the seed literally has been melted upon a good portion of the surface of the shell of the seed. Such a cavitation-effected seed will not germinate at all.

A typical sinusoidal ultrasound transmission could have been employed successfully if the seed had been rotated under the ultrasonic transmission, so that the damaging effects of sinusoidal ultrasound are minimized to the treated seed.

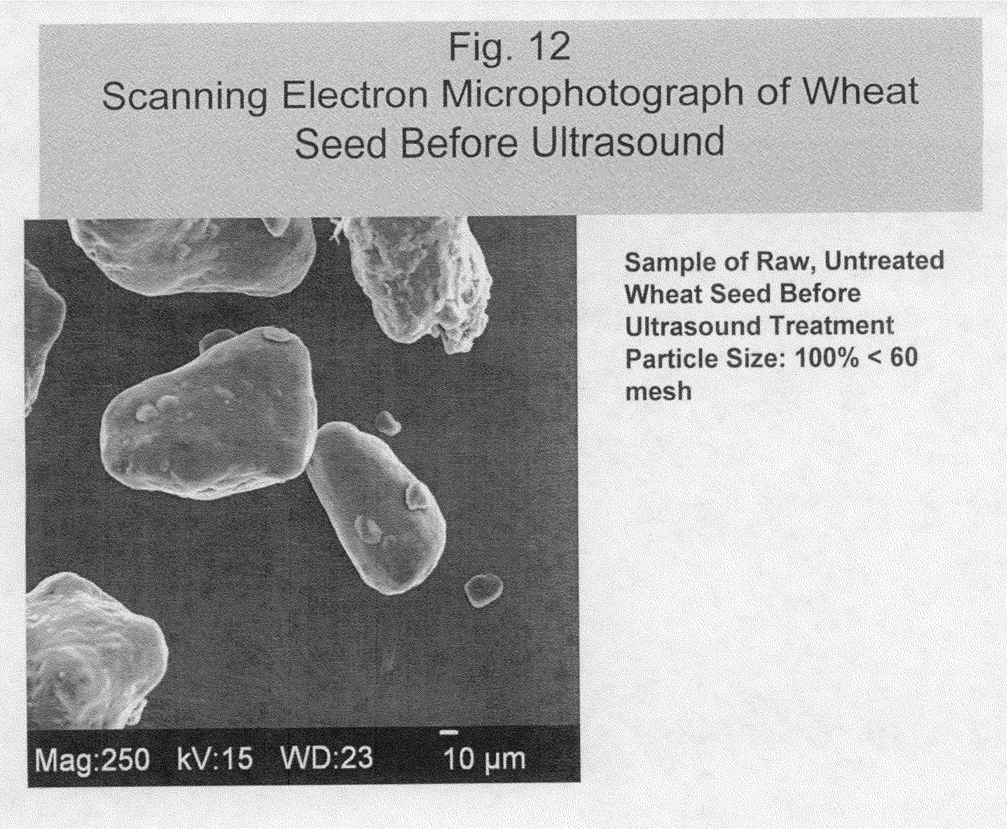

FIG. 12 is a microphotograph of the wheat seed in a raw untreated state. Note the outer shell of the seed remains intact and relatively smooth. Yet in FIG. 14 that same sample after 5 minutes of a typical sinusoidal ultrasound transmission has been fused and melted into a non-function seed material.

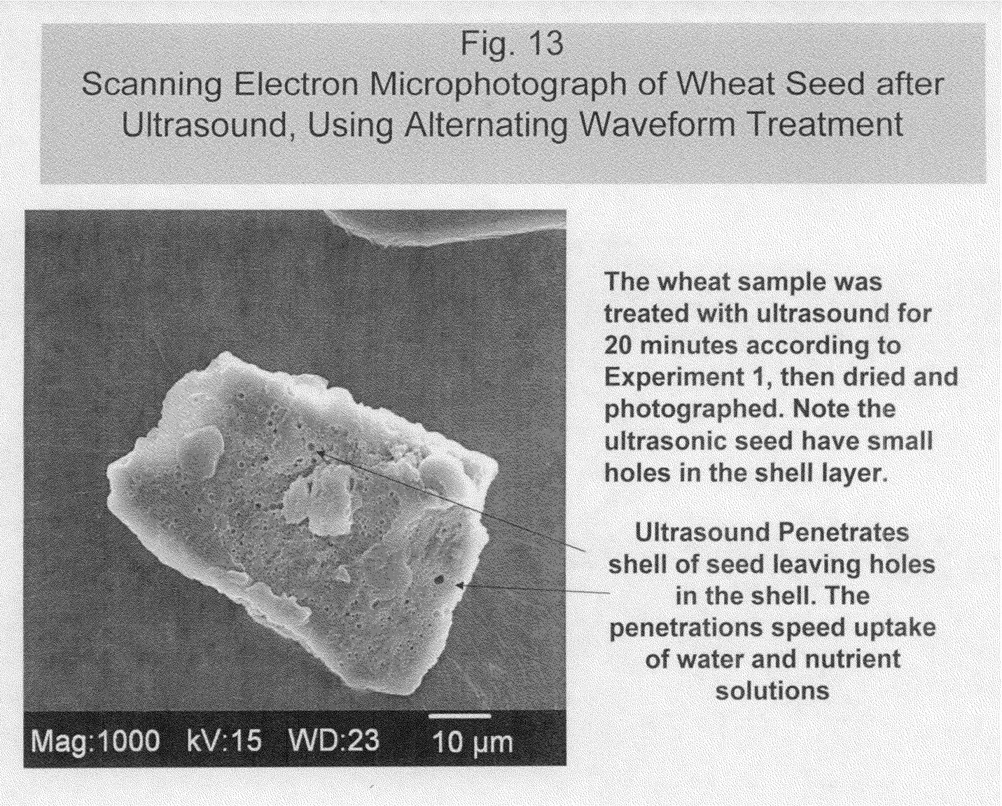

Under FIG. 13 the use of the alternating waveform approach (FIG. 5), has led to micro-pores in the seed shell which are clearly visible in the photograph. Applicant theorizes that these microporations enable the seed to absorb water and nutrients at a much faster rate that the raw seed, leading o faster germination of the seed, and thereby leading to reduced time for full plant growth. Applicant further theorizes that the alternating waveform ultrasonic transmission illustrated in FIG. 5 conducts two main functions when delivered to a target seed:
1) The saw tooth waveform is believed to exert a horizontal physical force upon the seeds shell surface which creates a tension in the seed to expand its pores.
2) Once the pores are enlarged the square wave form exerts a ramming force to the expanded pores. Essentially the square wave pushes nutrients, into the opened pores. Those nutrients can be water or fertilizing compounds within the water carrier or slurry.

The alternating waveform uses an ultrasonic duty cycle which is variable as to the time element employed in any timing of a particular waveform action. As an example:

TABLE 1
Duty Cycle Variations

| OPTION | SAWTOOTH WAVEFORM | SQUARE WAVE FORM |
|---|---|---|
| A | 50 milliseconds | 50 milliseconds |
| B | 20 milliseconds | 80 milliseconds |
| C | 80 milliseconds | 20 milliseconds |

TABLE 2
By Varying the Duty Cycle

| SEED TYPE | DUTY CYCLE VARIATION |
|---|---|
| Thin Shelled Seed | A |
| Thick Shelled Seed | B |
| For Crusty Shells | B |
| To remove the Shell outer protective coating | C |

Description of the Laboratory System

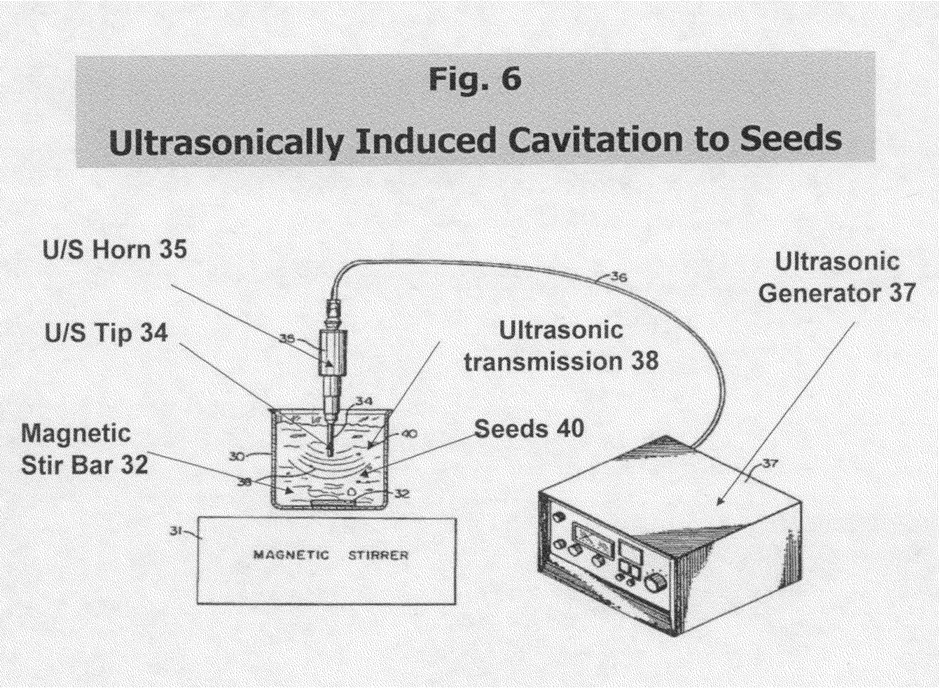

FIG. 6 illustrates a laboratory system used in the following listed experiments. In FIG. 6 an Ultrasonic Horn 35 is placed into a beaker 30 containing a solution of seeds and water 40. The Tip 34 of the ultrasonic transducer horn 35 is placed into the slurry 40 so that the Tip 34 is totally immersed in the liquid. At the bottom of the beaker 30 is a magnetic stir bar 32 which is forced to rotate by the electromagnetic force emanated from the magnetic stirrer 31, to which the beaker and apparatus is placed on top of. Power is delivered form the ultrasonic generator 37 through a cable 36 to the ultrasonic horn 35. The controller 33 for the ultrasonic generator was set to deliver a certain range of ultrasound to the seeds 40 within the slurry:

| | |
|---|---|
| Ultrasound Frequency | 20 kHz |
| Intensity at Horn Output | 0.5 W/sq. cm |
| Waveform Dynamic | 50 msecs Saw tooth/50 msecs Square wave |

After sonication, the seeds are dried, and then placed on a water-saturated filter pad, or in some cases, in wet soil, to induce germination. The temperature during germination has been varied to analyze the effect of the treatment on germination at various temperatures. Measurements which have been monitored in different experiments have included the time of emergence of the primary root, the time of emergence of secondary roots, the time for emergence of coleoptile, the root length and weight, the root area, the estimated volume of the root, the coleoptile length and weight, and the uptake of water. The seeds tested were first generation (F.sub.1) hybrid seed corn.

Continuous Apparatus

Ultrasonic Flow Cell Device

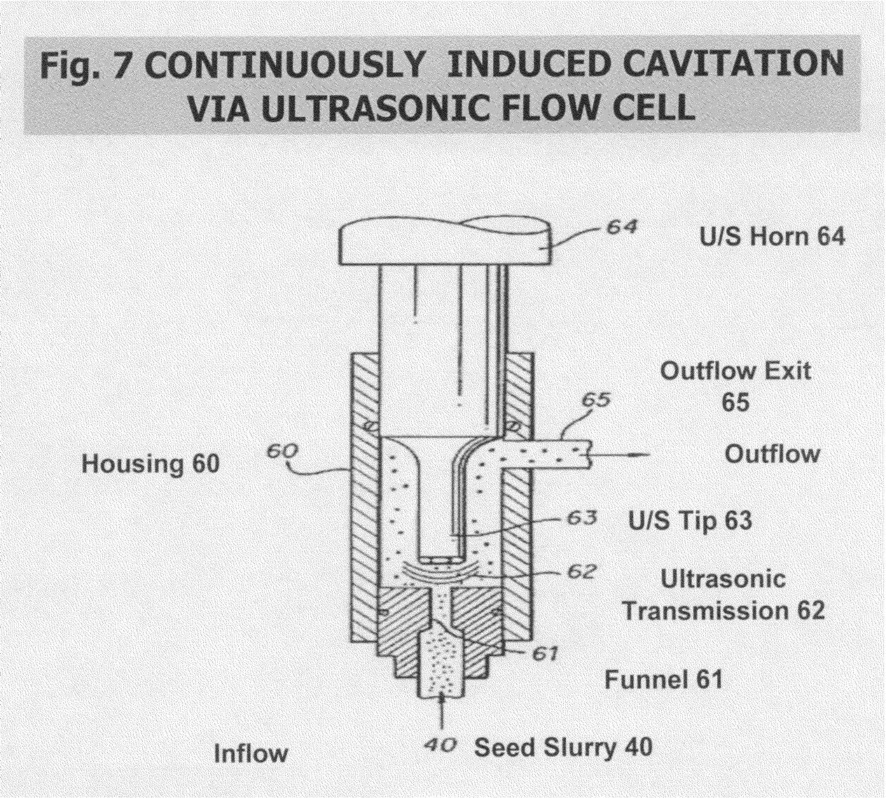

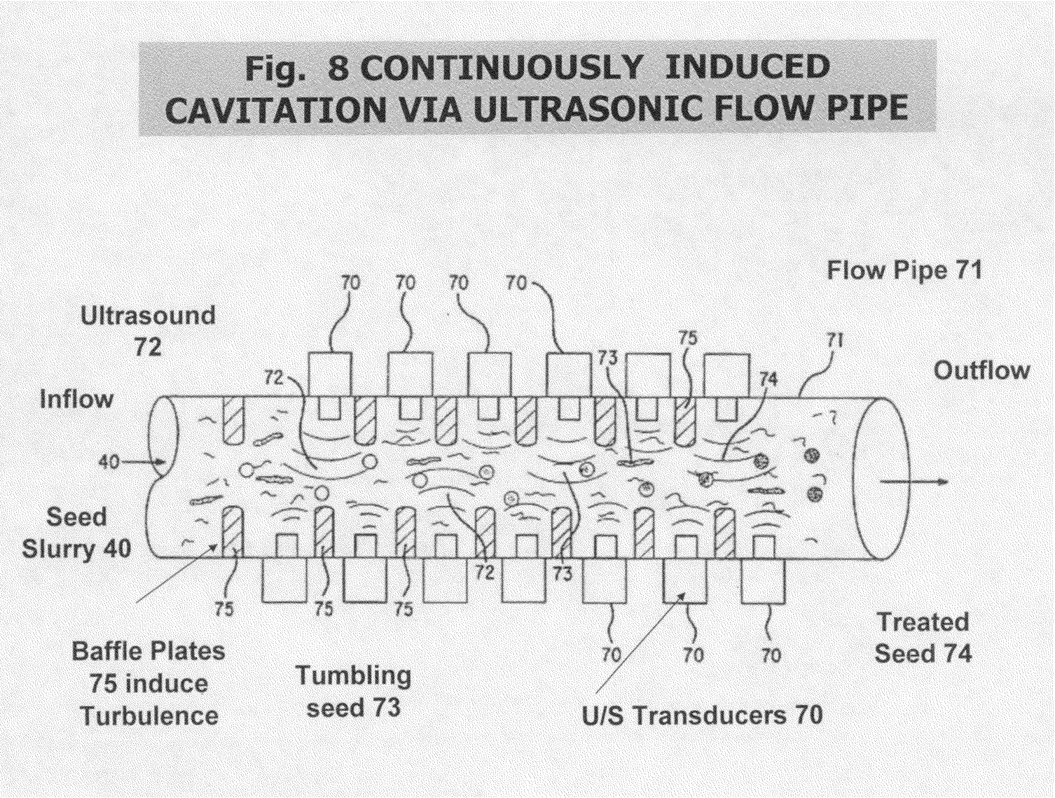

FIG. 7 and FIG. 8 illustrates a process where upon a commercial scale process could be employed. In FIG. 7 Seeds are dispersed in a liquid medium 40. An ultrasonic Horn transducer 64 is fitted within a housing 60 so that the ultrasonic Tip 63 is placed directly within the fluid flow of the seed slurry 40. The seed slurry 40 enters the housing through a funnel 61 which narrows the flow around the Tip 63. Ultrasound 62 from the Tip is directed to the seed slurry 40 as it passes in front of the Tip. Eventually the ultrasonically treated seed slurry 40 passes around the Tip 63 and out the Outflow Exit 65. In this manner a continuous flow of the seed slurry 40 can be ultrasonically treated by directing the flow of the seed slurry 40 across the ultrasound emitting tip 63 of the ultrasound horn 64.

The Tip 63 must be immersed in the liquid medium. The transducer is connected to an ultrasonic frequency generator. In the preferred embodiment of this Flow cell system, the sound transducer horn 64 is a piezoceramic transducer, Model VCX600 obtained commercially from Sonics and Materials, Inc. Alternative transducers may be used. Magnetorestrictive transducers are capable of delivering higher levels of sound energy to the liquid media and may be preferable if higher sound densities are desired, for example if large quantities of seed are to be sonicated. The frequency generator 9E is a Model 33120Q obtained commercially from Hewlett Packard and is matched to the transducer horn. It has a frequency range of between 15 kHz and 30 kHz and can supply between 0 and 500 watts to the sound transducer horn. In the experiments described herein, the power densities were between 30 watts per cm.sup.2 and 80 watts per cm.sup.2, although given the rated efficiency of the sound transducer 64 higher power densities can be achieved in the housing 60. Typically this apparatus will develop a sinusoidal ultrasonic waveform which can impart cavitation effects, as seen in FIGS. 3 and 4. The cavitation is believed to create or open pores within the seed enabling moisture topenetrate the treated seed.

Seeds are generally added at up to 30% in water by weight to produce seed slurry which is then added to the flow cell. The water solution could be tap water, or water that has been enhanced with a nutrient solution as an enhancer for the seed being ultrasonically processed. Nitrogen based or fertilizer based solutions are possible liquid vehicles. A stirrer may be employed at the inflow to the flow cell to cause the seeds within the slurry to rotate under the ultrasonic transmission. The seed mixture 40 can be processed once through the ultrasonic processor or may be subject to multiple cycles by recycling it through the processor more than once. Once processed the seed slurry are conveyed to a filter/dryer to remove the liquid and produce a dry seed product.

Continuous Ultrasonic Flow Pipe—FIG. 8

In order to provide a continuous ultrasonic treatment system a device involving an Ultrasonic Flow pipe 71 as illustrated in FIG. 8 may be used. In this system seed slurry 40 is conduced through a pipe lined with transducers. Ultrasound emanating from the transducers over the length of the pipe treats the seeds as they pass the length of the pipe. The seeds are passed through the Flow pipe continuously.

FIG. 8, the Flow Pipe 71 is lined with ultrasonic transducers 70. Within the pipe 71 are placed a series of Baffles 75 which will insert turbulence within the Pipe 70. Seed slurry 40 enters the pipe at one end and is subject to ultrasound treatment 72 as the seeds 40 tumble across the baffles 75 and finally exit. The tumbling action of the turbulence acts to rotate the seeds 73 within the slurry under the ultrasonic signal, 72. The treated seeds 74 exit the pipe at the outflow position. The seeds 40 are intended to be delivered at the inflow and at the Outflow under a continuous methodology, traveling and tumbling 73 through the pipe 71 under ultrasonic treatment 72 as they transverse the pipe 71. The system is also called an Ultrasonic Flow Cell.

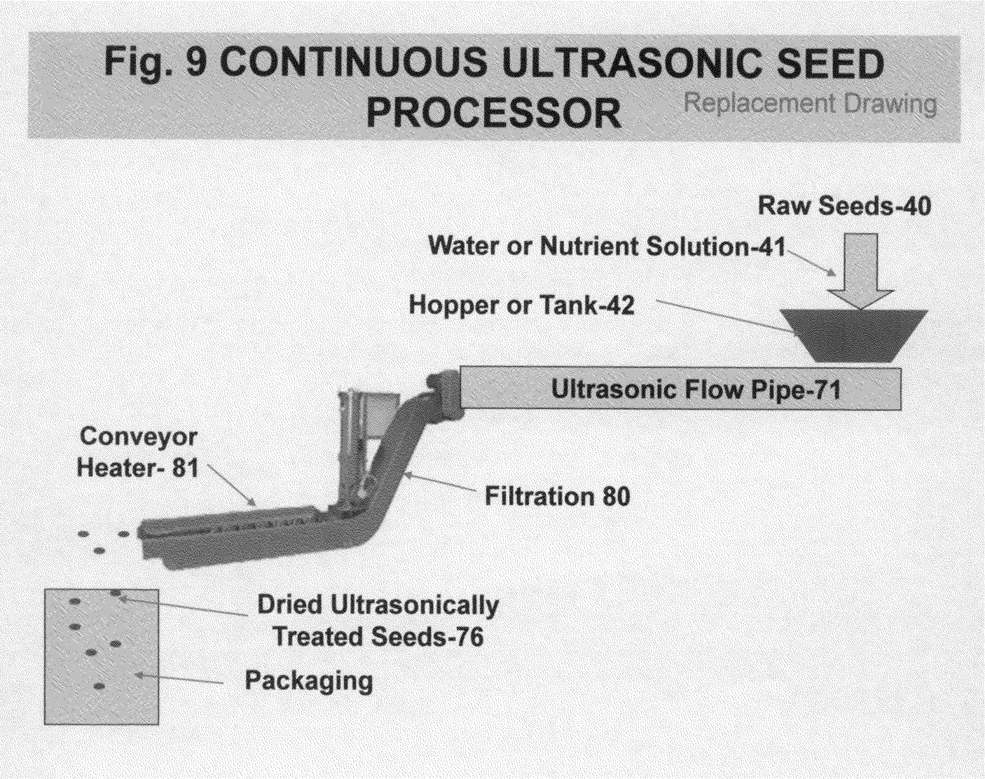

FIG. 9 shows that raw untreated seeds 40 are delivered via a hopper into the Ultrasonic Flow Cell 71. The raw untreated seeds 40 are mixed with water or a nutrient solution 41 in the hopper tank 42. Upon exiting the flow cell 71 the treated seed slurry 74 is delivered to a filter 80 which filters out the water or slurry leaving behind wet ultrasonically treated seeds 74. From there the wet seeds 74 are delivered to a conveyor heater 81, which drives off the remaining moisture on the treated seeds 74 producing a final dry produce ultrasonically treated seed 76, for packaging.

Transducer Design

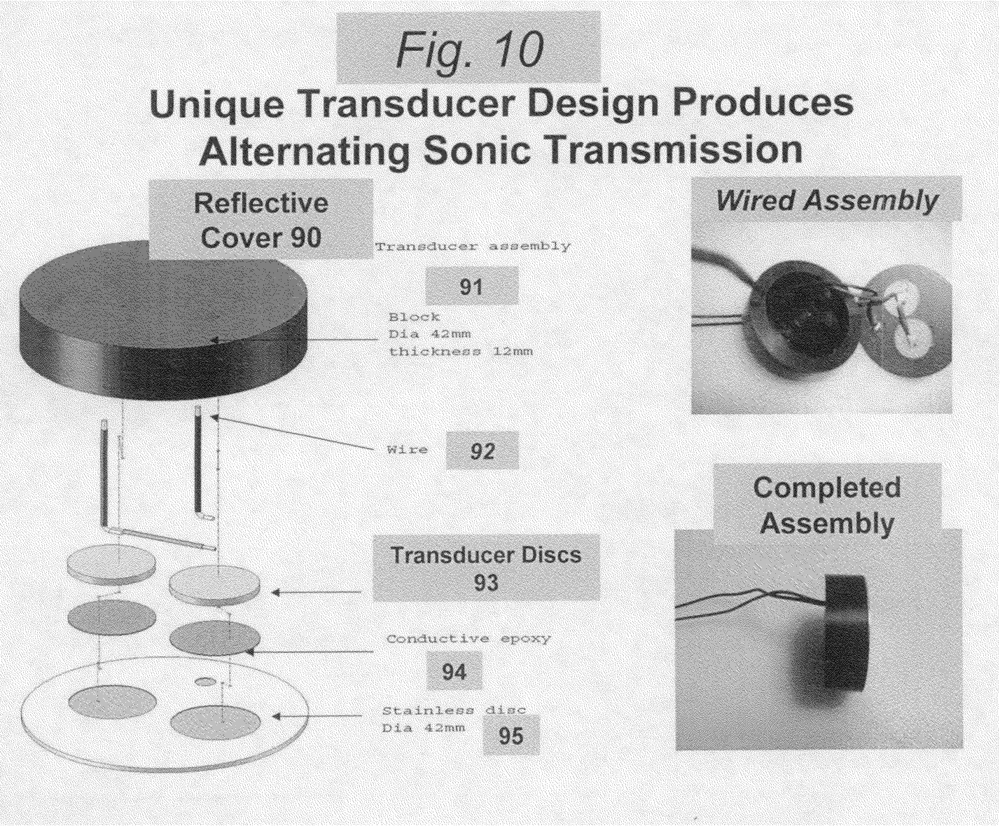

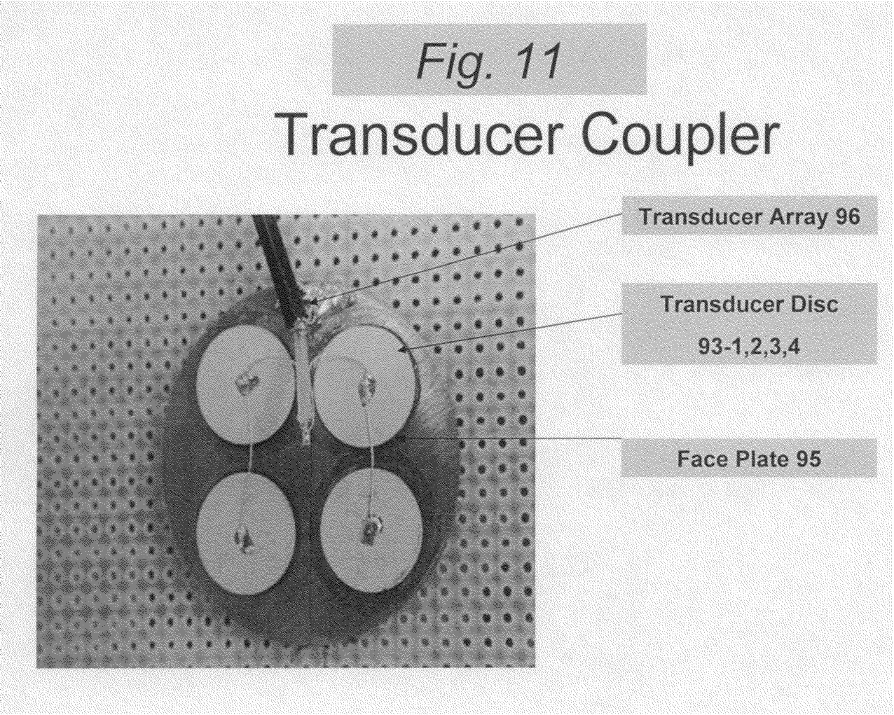

FIG. 10 and FIG. 11 show the design of the transducer apparatus (70 of FIG. 8) suitable for use in the Ultrasonic Flow Pipe installed along the length of the pipe (71 of FIG. 8).

In FIG. 10 an array of transducer discs 93 are connected to a stainless steel face plate 95 through the use of conductive epoxy 94. The transducer discs 93 could be 1 to 4 transducer elements arranged in an array of transducers 96 as seen in FIG. 11. A reflective block 91, which acts to focus the ultrasonic energy forward and to develop an alternating ultrasonic effect, which alternates from one waveform to another. The transducer of FIG. 10 consists of transducer assembly 93 with a back piece or Block 91 which is made of a nylon or plastic section. Wires 92 pass through the Block 91 to a ground on a metal face plate 95, which is generally a stainless steel disc, and to the top of a piezoelectric or magnetorestrictive transducer discs in the array 93. In the illustration of FIG. 10 two such discs are shown, adhered through the use of conductive epoxy 94 to the face plate 6G. A thin piece of foam rubber or a gasket is placed on the interior rim of the Block 91 and the entire assemblage is sealed using an epoxy to a final form as shorn in the Completed Assembly.

FIG. 11 illustrates a transducer disk array 06 configured with four transducer discs, 93-1, 2, 3 and 4, again adhered using conductive epoxy to the face plate 95.

The transducer array shown in FIGS. 10 and 11 will develop an alternating ultrasonic transmission as shown in FIG. 5. The preferred combination waveform is a saw tooth followed by a square wave ultrasonic transmission. The time on any particular waveform can be varied to create either waveform effect. Alternating ultrasound signals are intended to minimize any cavitation effect upon the skin of the seed and to avoid damage to seed shell but still speed uptake of moisture.

### EXPERIMENTS

A series of experiments were performed to demonstrate the effectiveness of the methods of the present invention. Experiments were conducted using the laboratory apparatus shown in FIG. 6. Four different crop seeds were examined, Wheat, Carrots, Corn and Tomatoes. Each was sonicated at the same ultrasonic setting, using the apparatus as shown in FIG. 6. Each experiment employed the alternating ultrasonic system as depicted in FIG. 5.

The ultrasonic settings for each experiment were:

TABLE 3

| | |
|---|---|
| Ultrasound Frequency | 20 kHz |
| Intensity | 0.5 W/sq. cm |
| Waveform Dynamic | 50 msecs Saw tooth/50 msecs Squarewave |
| P-P Voltage | 0.2-0.5 mV |

Seed slurry was developed consisting of 30% seeds in 70% tap water at ambient temperature. The seeds were added to the beaker of water right before the experiment and were sonicated for differing exposure times.

Time of Exposure in minutes

0
5
10
15
20

Samples were taken at each exposure time, filtered using a Buchner funnel and then allowed to air dry over night. The seeds were each then placed in a separate aquarium which was filled with potter soil at a depth as recommended for that seed. For example wheat was recommended in soil to a depth of 1.5 inches while carrots were to 7.5 inches. The aquariums were then placed on a window ledge to allow sunlight to reach the aquariums, but the aquariums were not exposed to the outside elements during the incubation period.

The seeds in the aquariums were examined every morning until they began to bud and emerge from the soil. The time to germination were compared to a control group that was not treated with ultrasound. The results are as indicated in the following experimental tables.

EXPERIMENT-1
Wheat Seeds under Ultrasonic
Treatment Vs. Untreated Control Samples

Bruce K. Redding, Jr.
1 Kathryn Lane
Broomall, PA 19008
P) 484-716-2165 F) 610-356-1866
E-Mail: bkredd@aol.com
Date: May 20, 2009
DELTA SEED TRIAL RESULTS

| Ultrasound Frequency | 20 kHz | |
|---|---|---|
| Intensity | 0.5 W/sq. cm | |
| Waveform Dynamic | 50 msecs Saw tooth/50 | |
| | msecs Squarewave | |
| P-P Voltage | 0.2-0.5 mV | |
| | WHEAT | |
| | BKR-1000-98 | |
| Normal time to Germinate | 7-10 | days |
| Normal time to Harvest | 89 | Days |
| Planting Depth | 1-1.5 | inches |

| Spacing/Row/Planting | 3.0 ft/12 inches | | |
|---|---|---|---|
| Time of | Days to | | |
| Ultrasonic Exposure | Germination | Loss in | % Savings in |
| in minutes | First Emergence | Days | Germination |
| 0 (Control Sample) | 11 | 0 | 0.0% |
| 5 | 7 | 4 | 36.4% |
| 10 | 5 | 6 | 54.5% |
| 15 | 4.8 | 6.2 | 56.4% |
| 20 | 4.1 | 6.9 | 62.7% |

FIG. 12 is a Scanning electron microphotograph of a collection of untreated, or raw, Wheat seeds.

FIG. 13 is a Scanning electron microphotograph of a collection of ultrasonically treated, Wheat seeds, processed according to Experiment 1. A close examination of the ultrasonically treated seeds shows several holes in the outer shell layer of the seed, created theoretically by the ultrasound exposure. The holes enable enhanced moisture absorption to the interior of the seed, increasing moisture absorption and resulting in a speedier germination profile.

EXPERIMENT-2
Carrot Seeds under Ultrasonic Treatment Vs.
Untreated Control Samples

Bruce K. Redding, Jr.
1 Kathryn Lane
Broomall, PA 19008
P) 484-716-2165 F) 610-356-1866
E-Mail: bkredd@aol.com
Date: May 20, 2009
DELTA SEED TRIAL RESULTS

| Ultrasound Frequency | 20 kHz | |
|---|---|---|
| Intensity | 0.5 W/sq. cm | |
| Waveform Dynamic | 50 msecs Saw tooth/50 | |
| | msecs Squarewave | |
| P-P Voltage | 0.2-0.5 mV | |
| | Burpee-Carrots-Danvers Hald Long | |
| | BKR-1000-102 | |
| Normal time to | 14-21 | Days |
| Germinate | | |
| Normal time to Harvest | 75 | Days |
| Planting Depth | 7.5 | inches |
| Spacing/Row/Planting | 2.5 | inches |

| Time of | Days to | | |
|---|---|---|---|
| Ultrasonic Exposure | Germination | Loss in | % Savings in |
| in minutes | First Emergence | Days | Germination |
| 0 (Control Sample) | 14 | 0 | 0.0% |
| 5 | 10 | 1 | 9.1% |
| 10 | 8 | 3 | 27.3% |
| 15 | 6.5 | 4.5 | 40.9% |
| 20 | 6.2 | 4.8 | 43.6% |

EXPERIMENT-3
Corn Seeds under Ultrastonic Treatment Vs.
Untreated Control Samples

Bruce K. Redding, Jr.
1 Kathryn Lane
Broomall, PA 19008
P) 484-716-2165 F) 610-356-1866
E-Mail: bkredd@aol.com
Date: May 20, 2009
DELTA SEED TRIAL RESULTS

| Ultrasound Frequency | 20 kHz | |
|---|---|---|
| Intensity | 0.5 W/sq. cm | |
| Waveform Dynamic | 50 msecs Saw tooth/50 msecs | |
| | Squarewave | |
| P-P Voltage | 0.2-0.5 mV | |
| | CORN-SWEET-KANDY KORN | |
| | HYBRID BKR-1000-101 | |
| Normal time to Germinate | 7-10 | days |
| Normal time to Harvest | 89 | Days |
| Planting Depth | 1-1.5 | inches |

| Spacing/Row/Planting | 3.0 ft/12 inches | | |
|---|---|---|---|
| Time of | Days to | | |
| Exposure | Germination | Loss in | % Savings in |
| in minutes | First Emergence | Days | Germination |
| 0 (Control Sample) | 7 | 0 | 0.0% |
| 5 | 5.5 | 5.5 | 50.0% |
| 10 | 5 | 6 | 54.5% |
| 15 | 3.8 | 7.2 | 65.5% |
| 20 | 3.8 | 7.2 | 65.5% |

EXPERIMENT-4
Tomato Seeds under Ultrasonic Treatment Vs.
Untreated Control Samples

Bruce K. Redding, Jr.
1 Kathryn Lane
Broomall, PA 19008
P) 484-716-2165 F) 610-356-1866
E-Mail: bkredd@aol.com
Date: May 20, 2009
DELTA SEED TRIAL RESULTS

| Ultrasound Frequency | 20 kHz | |
|---|---|---|
| Intensity | 0.5 W/sq. cm | |
| Waveform Dynamic | 50 msecs Saw tooth/50 msecs | |
| | Squarewave | |
| P-P Voltage | 0.2-0.5 mV | |
| | Sweet Smart Tomato Beefmaster Hybrid | |
| | BKR-1000-098 | |
| Normal time to Germinate | 7-10 | days |
| Normal time to Harvest | 80 | Days |
| Planting Depth | 0.25 | inches |

| Spacing/Row/Planting | 2.5 ft/2.0 ft | | |
|---|---|---|---|
| Time of | Days to | | |
| Exposure | Germination | Loss in | % Savings in |
| in minutes | First Emergence | Days | Germination |
| 0 (Control Sample) | 7 | 0 | 0.0% |
| 5 | 5 | 6 | 54.5% |
| 10 | 4.7 | 6.3 | 57.3% |
| 15 | 4.2 | 6.8 | 61.8% |
| 20 | 3.9 | 7.1 | 64.5% |

TABLE 4
Ultrasonically Treated Tomato
Found Germination Pattern

| Crop | TOMATO |
|---|---|
| Normal Germination days | 7 |
| U/S Days to Germinate | 3.90 |
| U/S Savings in Days | 3.10 |
| U/S Savings in % | 44% |

This program was set to test both the germination times for a control seed vs. an Ultrasound treated seed.
The results show the U/S version germinated in 3.10 days vs. 7-10 days, a minimal savings of time of −44%.

TABLE 5
Ultrasonically Treated Tomato
Found Growth Pattern to Maturity

| Crop | TOMATO |
|---|---|
| Normal Germination days | 7 |
| U/S Days to Germinate | 3.90 |
| U/S Savings in Days | 3.10 |
| U/S Savings in % | 44% |
| Normal days to Harvest | 80 |
| U/S Harvest Reduction | 35 |
| U/S Savings in Days | 45 |

### EXPERIMENTAL SUMMARY

The summary of the experiments is listed below. In each case of ultrasonic sonification the sonicated seed germinated at a faster rate. The control seeds germinated in 7-14 days while the sonicated seeds germinated in 4 to 6 days. The germination savings in terms of days for germination ranged from −41% for the sonicated wheat seed to −56% for the carrots.

After being germinated the sonicated and the control seeds were then transferred from the incubating Petri aquariums to an outside Test Farm, where the seeds were planted to the recommended normal depth for that plant in conventional soil and allowed to grow into a mature plant.

Generally the control plants matured in 75-89 days, approximating the listed plant growth times. The sonicated plants took from 35-42 days to mature and were comparable in size, integrity and even fruit size and characteristics for the tomato crop to the control unsonicated group.

Sonication saved 33 to 52 Days in harvest time.

Planting Trial Results for Ultrasonically Treated Tomato Seeds, Grown to Full Maturity and Harveted.

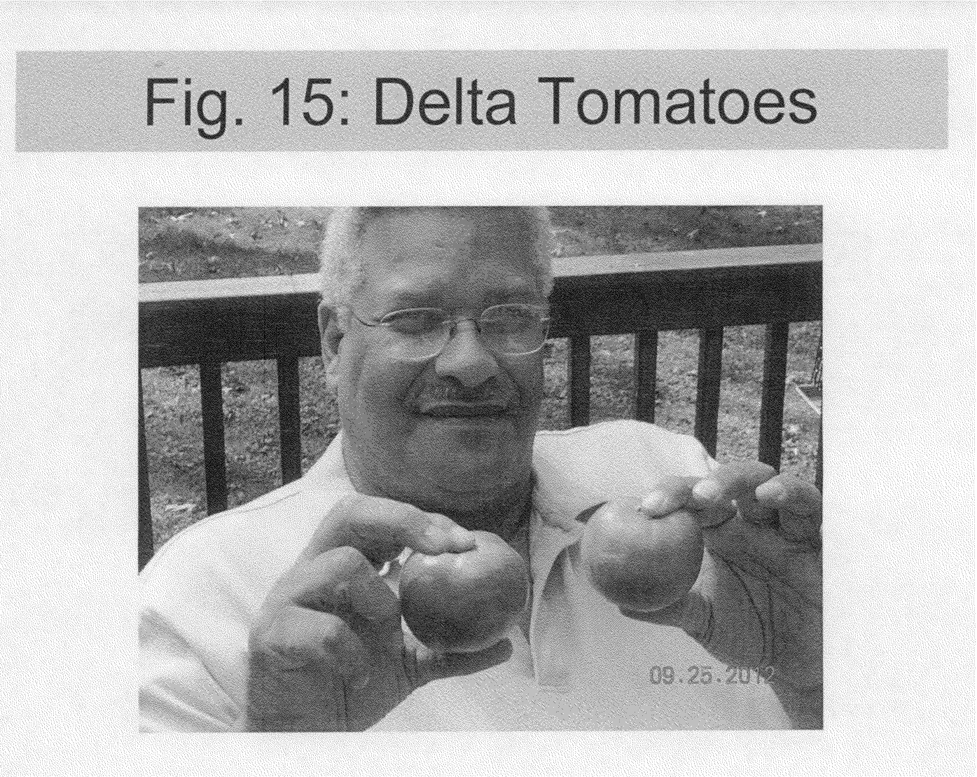

FIG. 15 is a photograph of the control seed, un-sonicated tomato seed resultant fruit vs. the 20 minutes sonicated seed fruit when the plant grew to full maturity after planning the seeds.

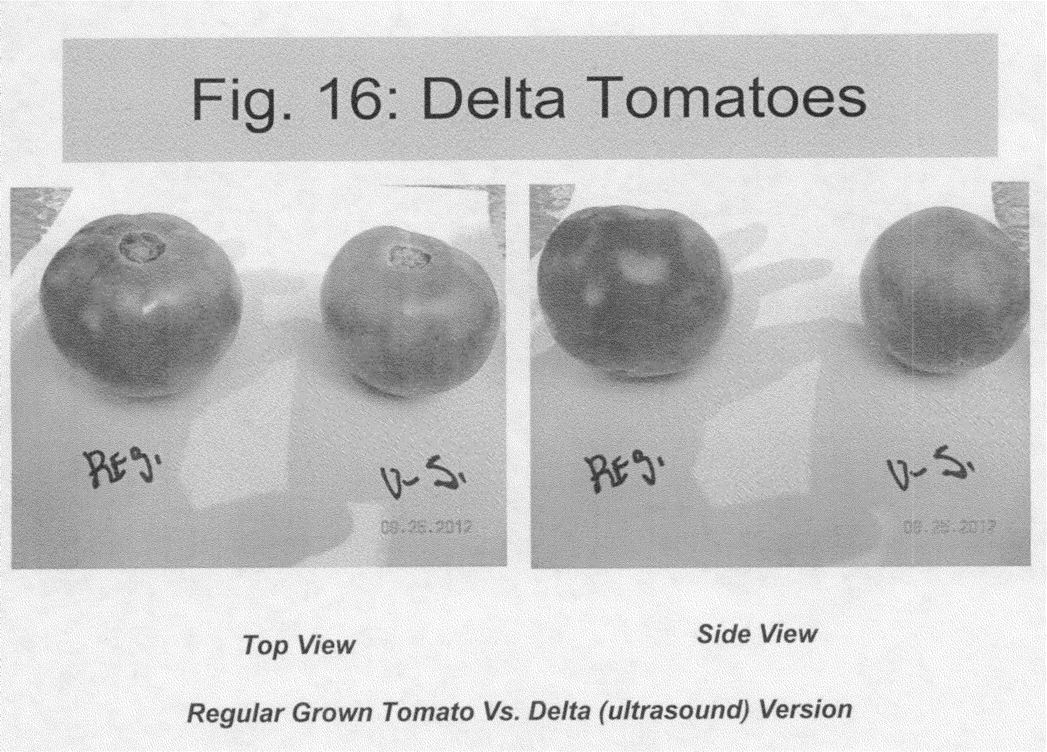

FIG. 16 is a photograph of regularly grown tomato (Grown to maturity in 80 days) Vs. Ultrasonically treated Tomato seeds (grown to maturity in 35 days), both top and side views.

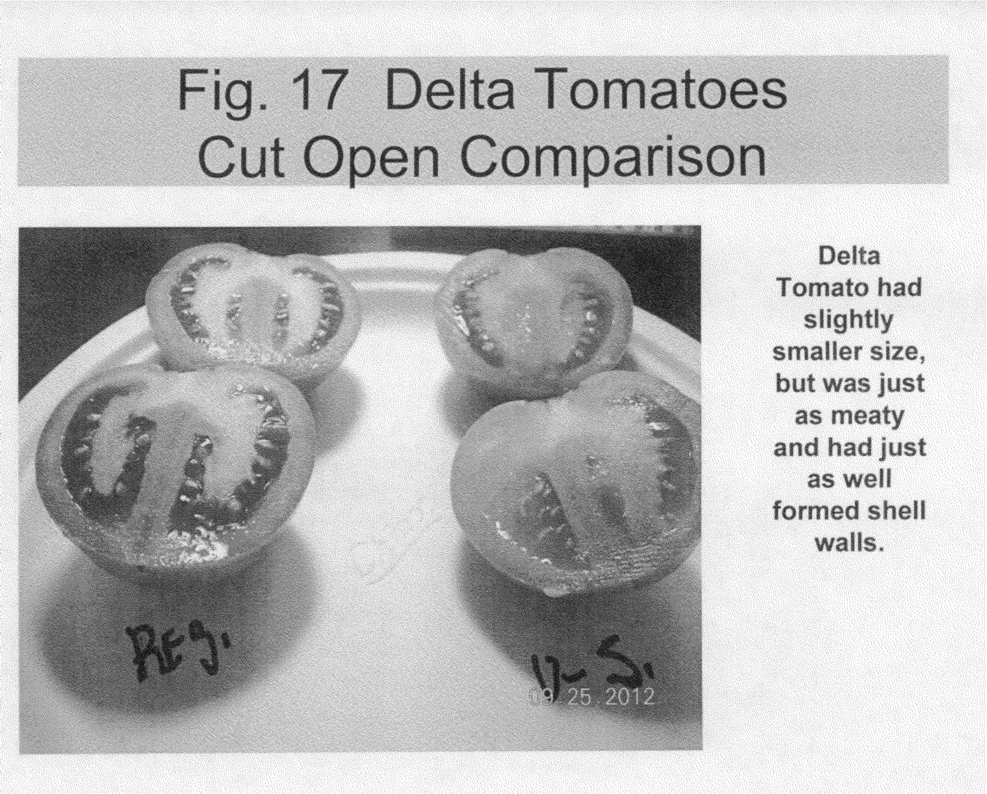

FIG. 17 is a photograph of regularly grown tomato (Grown to maturity in 80 days) Vs. Ultrasonically treated Tomato seeds (grown to maturity in 35 days), both cut open views to show the meat of the fruit.

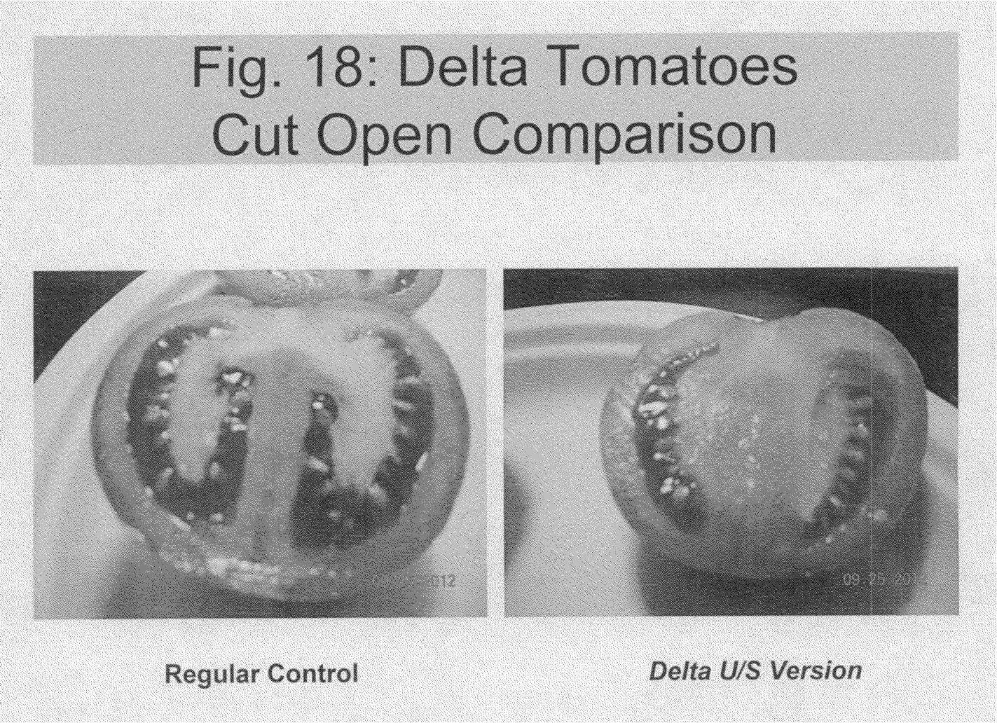

FIG. 18 is a close up photograph of regularly grown tomato (Grown to maturity in 80 days) Vs. Ultrasonically treated Tomato seeds (grown to maturity in 35 days), both cut open views to show the meat of the fruit.

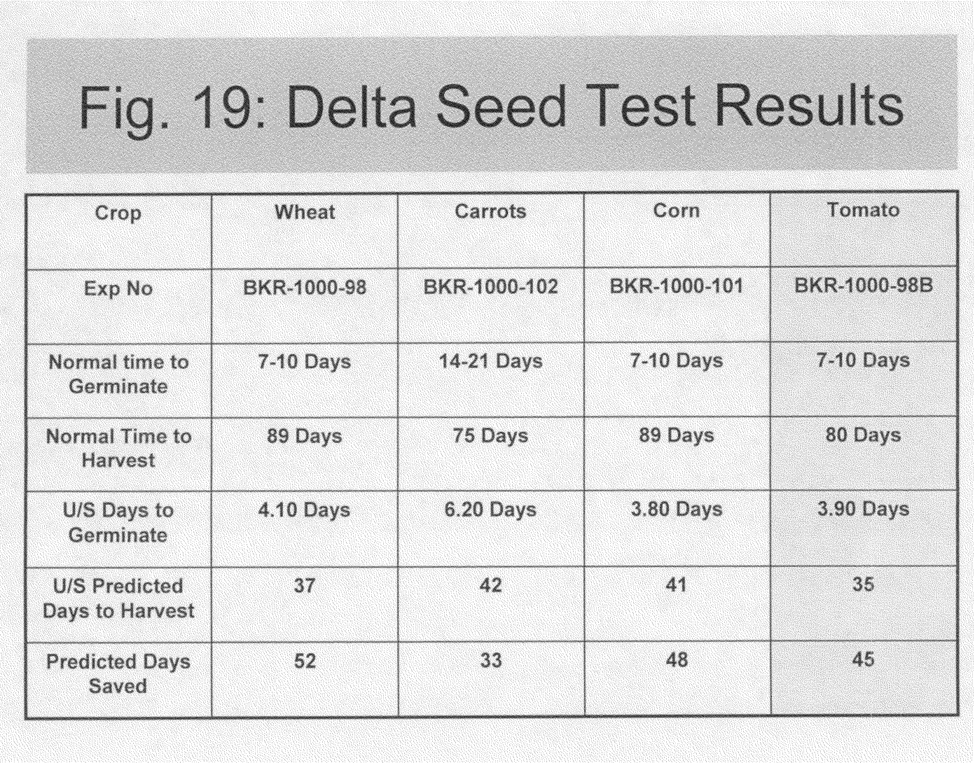

FIG. 19 is a summary of the germination advances and the advances discovered in the full planting of the test crops using this invention to speed harvest times for the select crops.

TABLE 6
EXPERMIMENTAL SUMMARY

Bruce K. Redding, Jr.
Email: bkredd@aol.com
Transdermal Specialties
1 Kathryn Lane
Broomall, PA 19008 USA
Phone 484-716-2165
Fax: 610-356-1866
www.transdermalspecialties.com
CONFIDENTIAL

| | | | | | | | SWEET | |
|---|---|---|---|---|---|---|---|---|
| | | | | | CORN- | | SMART | |
| | | | | | SWEET- | | TOMATO | |
| | | | | | KANDY | | BEEF- | |
| | | | | | KORN | | MASTER | |
| | WHEAT | | CARROTS | | HYBRID | | HYBRID | |
| Experimental | BKR-1000- | | BKR-1000- | | BKR-1000- | | BKR-1000- | |
| No. | 98 | | 102 | | 101 | | 098 | |
| Normal time | 7-10 | days | 14-21 | Days | 7-10 | days | 7-10 | days |
| to Germinate | | | | | | | | |
| Normal time | 89 | Days | 75 | Days | 89 | Days | 80 | Days |
| to Harvest | | | | | | | | |
| Planting | 1-1.5 | inches | 7.5 | inches | 1-1.5 | inches | 0.25 | inches |
| Depth | | | | | | | | |

| | | | | | |
|---|---|---|---|---|---|
| Spacing/Row/ | 3.0 ft/12 | 2.5 | inches | 3.0 ft/12 | 2.5 ft/2.0 ft |

| Planting | inches | | inches | |
|---|---|---|---|---|
| | ULTRASOUND EFFECTS | | | |
| Crop | WHEAT | CARROTS | CORN | TOMATO |
| Normal | 7 | 14 | 7 | 7-10 |
| Germination | | | | |
| days | | | | |
| U/S Days to | 4.10 | 6.20 | 3.80 | 3.90 |
| Germinate | | | | |
| U/S Savings | 2.90 | 7.80 | 3.20 | 3.10 |
| in Days | | | | |
| U/S Savings | 41% | 56% | 46% | 44% |
| in % | | | | |
| Normal days | 89 | 75 | 89 | 80 |
| to Harvest | | | | |
| U/S Harvest | 37 | 42 | 41 | 35 |
| Reduction | | | | |
| U/S Savings | 52 | 33 | 48 | 45 |
| in Days | | | | |

TABLE 7
Ultrasonically Treated Seed Test Results

| Crop | Wheat | Carrots | Corn | Tomato |
|---|---|---|---|---|
| Exp No | BKR-1000- | BKR-1000- | BKR-1000- | BKR-1000- |
| | 98 | 102 | 101 | 98B |
| Normal | 7-10 Days | 14-21 Days | 7-10 Days | 7-10 Days |
| time to | | | | |
| Germinate | | | | |
| Normal | 89 Days | 75 Days | 89 Days | 80 Days |
| Time to | | | | |
| Harvest | | | | |
| U/S Days to | 4.10 Days | 6.20 Days | 3.80 Days | 3.90 Days |
| Germinate | | | | |
| U/S | 37 | 42 | 41 | 35 |
| Predicted | | | | |
| Days to | | | | |
| Harvest | | | | |
| Predicted | 52 | 33 | 48 | 45 |
| Days | | | | |
| Saved | | | | |

While the above experiments were conducted using the apparatus described in FIG. 6, the inventor believes that a transducer configuration as described in FIGS. 10 and 11 would achieve the same sonification effect as a sinusoidal ultrasonic transmission, without generating cavitation when applied to a continuous ultrasonic treatments system as depicted in FIG. 7, 8 or 9.

Cavitation generates heat energy as well as mechanical forces, as shown in FIG. 3 and FIG. 4. For certain seeds cavitation could burn the seed and cause damage as seen in FIG. 14. The alternating ultrasonic waveform system as shown in FIG. 5 proved to be less damaging to the seeds than the cavitation ultrasound but still opened channels in the seed shell which could speed the uptake of moisture and nutrients into the seed. Refer to FIG. 13 where the alternating ultrasonic waveform system produced very gentle perforations in the seed shell without burning the shell in wheat seeds.

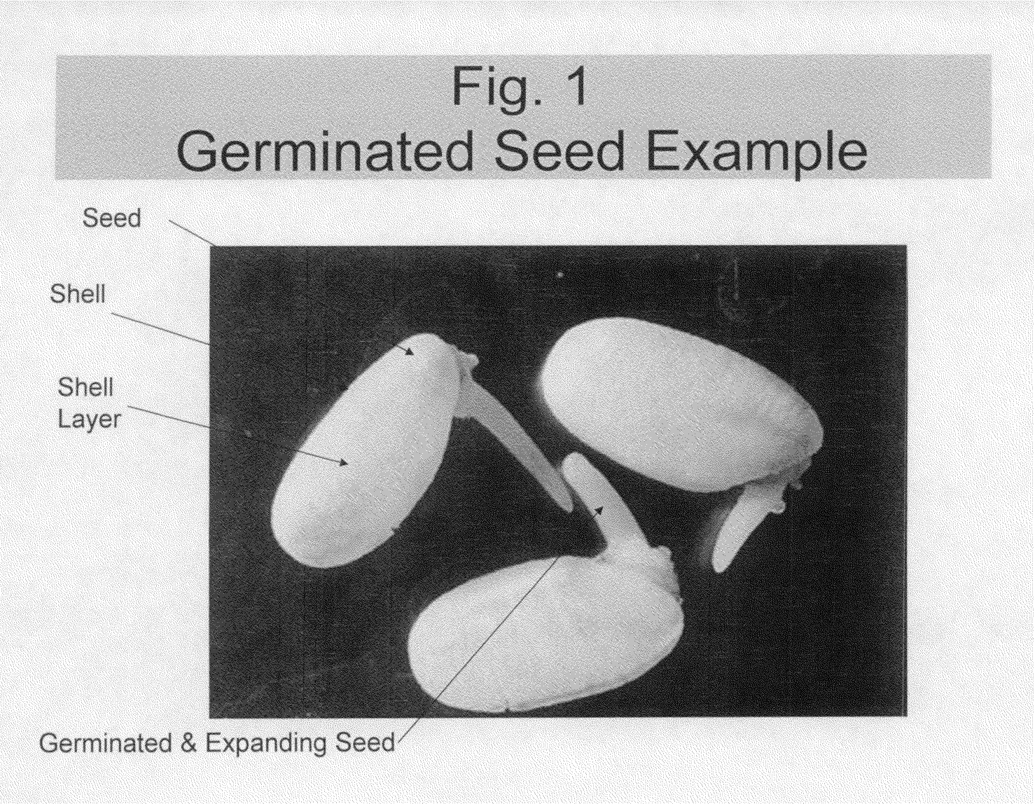

Many of the seeds treated with sinusoidal ultrasound indicated structure damage after just 5 minutes of exposure, see FIG. 14. The Seeds treated with alternating ultrasonic energy, sawtooth waveform for 50 msecs followed by saw tooth waveform for 50 msecs, showed a more extensive permeation of the seed's outer shell layer with no burning effects, as seen in FIG. 13. In FIG. 14 the seed, treated with ordinary sinusoidal ultrasound, exhibited a melting of the shell layer over the seed shell (FIG. 1).

Therefore the preferred embodiment is one using the alternating ultrasound treatment, but conventional sinusoidal ultrasound may still be preferable in certain seed cases, as long as the seed is rotated under the ultrasonic transmission.

### SUMMARY

The experimentation listed above showed that ultrasound-induced water uptake represents a unique event dissociable from normal water uptake. The differences in uptake rates of sonicated and the control soaked seeds showed that the sonicated seeds exhibit a much faster rate of germination than the non-sonicated seeds.

These results demonstrate that ultrasound-stimulated seeds probably have faster rates of water uptake is achieved very rapidly compared to the rates of water uptake of just soaked seeds. Thus, the sonication process fundamentally enhances the rate of uptake of substances into the seeds, speeding both seed germination and the growth of mature plants and crops. This process may therefore be used to reduce the time-to-harvest for many crops by first ultrasonically treating the seeds.

Additionally, results demonstrate that ultrasound treatment alters seed without negatively affecting the proportion of seeds that germinate. Ultrasound treatment causes an accelerated increase in seed hydration. The effect of ultrasound is not to drive water into the seed, but rather to alter the seed so that it will take-up water at an enhanced rate, even in the absence of ultrasound. This enhanced deposition effect is stable. It is maintained when seed is dried and stored after ultrasound treatment. Ultrasound does not negatively affect germination. The ability to separate the sonication and deposition steps without diminishing the enhanced deposition effect results in significant practical advantages. The seed can receive ultrasonic cavitational treatment at a first point of time, and after waiting a predetermined period of time, the seed will exhibit an enhanced ability to imbibe a substance. This allows for sonicating the seed, and storing the seed until planting or processing begins. At this later date, the decision about what substance to imbibe into the seed can be specifically tailored to the then existing planting, growth, or processing conditions. This allows for more efficient and timely preparation of the seed. Further, the imbibing step does not require sophisticated equipment or technical expertise, and thus can be performed in the field.

FIG. 8 illustrates the preferred embodiment incorporating an ultrasonic flow pipe with means to provide for the tumbling of a seed under ultrasonic treatment, and thereby enabling large scale processing of the sonification of seeds on a continuous basis, FIG. 9. producing ultrasonically treated seeds on a continuous treatment basis with results similar to the laboratory apparatus illustrated in FIG. 6

### SUMMARY

Those of ordinary skill in the art will understand that by demonstrating the basic technique of enhanced deposition with a substance like water, any other type of substance can be imbibed into the seed in the same manner. As mentioned hereinabove, these substances can include water, pesticides, insecticides, herbicides, fungicides, and growth hormones; however, the applicability of the invention is not limited to these substances. The enhanced deposition method can be used with substances that enhance any growth characteristic of the seed and the resultant plant, or otherwise add value to the seed during commercial processing. For example, the method of the present invention could be used to imbibe into a seed substances that would inhibit germination for certain predetermined periods of time. Delaying germination in this manner would prove beneficial in commercial farming by allowing growers to plant seed prior to the occurrence of optimum planting or germination conditions. This would relieve growers of the burden of planting their entire crop at once when the soil and weather conditions reach a preferred state for planting. Thus, the substances contemplated for use with the present invention need not necessarily be substances that make a plant grow faster, stronger, or resistant to pests in some manner.

Crops emerging from ultrasonically treated seeds in the manners described above tend to have full growth plants and far less time to harvest than untreated crops.

Although the invention has been described with respect to a preferred embodiment thereof, it is to be also understood that it is not to be sole limited since changes and modifications can be made therein which are within the full intended scope of this invention as defined by the appended claims.

I claim:

1. A sonication and deposition process for the uptake of a substance into a seed, comprising the steps of: a) immersing said seed in water or solution of water and other nutrients b) introducing into said water sound energy at a frequency and energy density sufficient to create cavitation in said liquid; c) sonicating said seed for a period of time sufficient to result in an alteration of said seed such that said sonically treated seed takes a substance into said seed at an improved rate of uptake, wherein said substance is capable of enhancing a growth characteristic of said seed and any resultant plant or crop thereafter, wherein said process may be in the form of batch or continuous seed treatment system employing an ultrasonic flow cell or continuous ultrasonic flow pipe.

2. The invention in accordance with claim 1 wherein said seed can be any plant, including decorative plants or plants for human or animal consumption, or for the production of plant derived fuels.

3. The invention in accordance with claim 1 wherein said sound energy is at a frequency of between about 15 kHz and about 100 kHz.

4. The invention in accordance with claim 1 wherein said sound energy is at an energy density of between about 0.125 watt/cm.sup.2 and about 10 watts/cm.sup.2.

5. The invention in accordance with claim 1 wherein said sound energy is sinusoidal and may or may not generate cavitation energies to the treated seed.

6. The invention in accordance with claim 6 wherein said sound energy is applied for period greater than 1 minute.

7. A sonication and deposition process for the uptake of a substance into a seed, comprising the steps of: a) immersing said seed in water or solution of water and other nutrients b) introducing into said water sound energy, possessing alternating ultrasonic waveforms, which rotate from one wave form to another in periodic time periods, at a frequency and energy density sufficient to minimize cavitation in said liquid; c) sonicating said seed for a period of time sufficient to result in an alteration of said seed such that said sonically treated seed takes a substance into said seed at an improved rate of uptake, wherein said substance is capable of enhancing a growth characteristic of said seed and any resultant plant or crop thereafter, wherein said process may be in the form of batch or continuous seed treatment system employing an ultrasonic flow cell or continuous ultrasonic flow pipe.

8. The invention in accordance with claim 7 wherein said seed can be any plant, including decorative plants or plants for human or animal consumption, or for the production of plant derived fuels.

9. The invention in accordance with claim 7 wherein said sound energy is at a frequency of between about 15 kHz and about 100 kHz.

10. The invention in accordance with claim 7 wherein said sound energy is at an energy density of between about 0.125 watt/cm.sup.2 and about 10 watts/cm.sup.2.

11. The invention in accordance with claim 7 wherein said sound energy is not sinusoidal alone, but a alternating sonic waveform, alternating periodically between saw tooth and square waveforms or some other combination alternating between sine, saw tooth, triangular or square wave forms for the purpose of minimizing damage or reducing cavitation energies to the treated seed.

12. The invention in accordance with claim 7 wherein said sound energy is applied for period greater than 1 minute.

13. A sonication and deposition process for speeding the germination of plants which may be used for crops or for fuel, involving the immersion of the seed in a vessel and application of ultrasound in a batch process, whether that ultrasound induces cavitation or uses a alternating ultrasonic transmission, to induce and speed water or nutrient solution into the ultrasonically treated seed, wherein the resultant harvest time for plants emerging from the sonically treated seed is reduced from ordinary untreated seed, wherein said process may be in the form of batch or continuous seed treatment system employing an ultrasonic flow cell or continuous ultrasonic flow pipe.

14. A sonication and deposition process for speeding the germination of plants which may be used for crops or for fuel, involving the immersion of the seed in a vessel and application of ultrasound in a continuous process involving a ultrasound flow cell, whether that ultrasound induces cavitation or uses a alternating ultrasonic transmission, to induce and speed water or nutrient solution into the ultrasonically treated seed, wherein the resultant harvest time for plants emerging from the sonically treated seed is reduced from ordinary untreated seed, wherein said process may be in the form of batch or continuous seed treatment system employing an ultrasonic flow cell or continuous ultrasonic flow pipe.

15. A sonication and deposition process for speeding the germination of plants which may be used for fuel or for fuel additives, or other crops, involving the immersion of the seed in a vessel and application of ultrasound in either a batch or a continuous process involving a ultrasound flow cell or a baffled pipe lined with ultrasonic transducers, whether that ultrasound induces cavitation or uses a alternating ultrasonic transmission, to induce and speed water or nutrient solution into the ultrasonically treated seed, wherein the resultant harvest time for plants emerging from the sonically treated seed is reduced from ordinary untreated seed, wherein said process may be in the form of batch or continuous seed treatment system employing an ultrasonic flow cell or continuous ultrasonic flow pipe.

16. The plants for fuel applications according to claim 15 to include sulfurous acid water into a corn kernel, comprising the steps of: a) immersing a corn kernel in a liquid solution comprised of sulfurous acid, water and a dissolved gas wherein said liquid solution is capable of softening the corn kernel; b) introducing into said liquid solution sound energy at a frequency and energy density sufficient to create cavitation in said liquid solution; c) sonicating said corn kernel for a period of time sufficient to result in an alteration of said corn kernel such that said corn kernel takes on a memory for an improved rate of uptake of a substance into said corn kernel; d) waiting a predetermined amount of time; and e) imbibing said corn kernel with said substance after said predetermined amount of time.

17. The invention in accordance with claim 16 wherein said liquid solution further comprises gibberellic acid.

18. A seed with a memory for an improved rate of uptake of a substance treated according to the process of claim 16.

19. The invention in accordance with claim 16 wherein said substance is a substance that inhibits germination of said seed.

20. The method of claim 16, wherein the ultrasound is applied continuously.

21. The method of claim 16, wherein the ultrasound is pulsed.

22. A device or assembly for the ultrasonic treatment of seeds wherein said device contains a circuit means comprising wave form generator means for generating an ultrasonic signal formed of a saw tooth wave in a frequency range of between 20 kHz and 100 kHz and of a square wave superimposed thereon in a frequency range of between 20 kHz and 100 kHz, preferably but any combination waveform employing one form of ultrasonic waveform followed by another different form of waveform.

23. A device or assembly for the ultrasonic treatment of seeds wherein said device contains a circuit means comprising wave form generator means for generating an ultrasonic signal formed of a saw tooth wave in a frequency range of between 20 kHz and 100 kHz and of a square wave superimposed thereon in a frequency range of between 20 kHz and 100 kHz, preferably but any combination waveform employing one form of ultrasonic waveform followed by another different form of waveform, wherein seeds are conveyed into said device by means of a flow cell around the transducer element of the device.

24. A device or assembly for the ultrasonic treatment of seeds wherein said device contains a circuit means comprising wave form generator means for generating an ultrasonic signal formed of a saw tooth wave in a frequency range of between 20 kHz and 100 kHz and of a square wave superimposed thereon in a frequency range of between 20 kHz and 100 kHz, preferably but any combination waveform employing one form of ultrasonic waveform followed by another different form of waveform, wherein seeds are conveyed into said device by means of a baffled pipe lined with multiple transducers which will effect the seeds as they travel the length of the pipe.
TRANSDUCER

25. A transducer assembly employing; an array of transducers discs or elements which are affixed by means of a conductive epoxy, or other appropriate means to a metal plate or disc, with the transducers wired on their top surface in parallel and a negative or ground wired to the metal plate or disc, and the entire plate bordered by a hollow ring of foam rubber such as neoprene and then sealed within an insulating block composed of a plastic material such as urethane which will isolate and protect the transducers from contact with moisture or any exterior environment, said sealed transducer discs or elements in an insulating block being powered by an oscillating circuit to produce ultrasonic emissions to the plate, which in harmonic response, delivers an ultrasonic transmission over a surface area larger than that of the individual transducer discs from the assemblage.

26. An ultrasonic transducer assembly suitable for use in ultrasonic seed treatment applications employing a single cymbal type ultrasonic transducer design according to the type disclosed in U.S. Pat. No. 4,999,819 Newnham, et al; U.S. Pat. No. 5,276,657 Newnham, et al and U.S. Pat. No. 5,729,077 Newnham, et al.

27. An ultrasonic transducer assembly suitable for use in ultrasonic seed treatment applications employing a stacked configuration cymbal type ultrasonic transducer design according to the type disclosed in U.S. Pat. No. 5,729,077 Newnham, et al, wherein two or more transducers are stacked on top of one another for the purpose of increasing the intensity of an ultrasonic transmission while also increasing the power efficiency of the transducer system as a whole.
